(19) United States
(12) Patent Application Publication
(10) Pub. No.: US 2006/0010003 A1
(43) Pub. Date: Jan. 12, 2006

(54) User-capability-tailored transfer of digitally encoded content

(76) Inventor: Sky Kruse, Seattle, WA (US)

Correspondence Address: OLYMPIC PATENT WORKS PLLC, P.O. BOX 4277, SEATTLE, WA, 98104, US

(21) Appl. No.: 11/175,906

(22) Filed: Jul. 5, 2005

Related U.S. Application Data
(60) Provisional application No. 60/585,103, filed on Jul. 2, 2004.

(51) Int. Cl. G06Q 99/00

(52) U.S. Cl. 705/1

(57) ABSTRACT

In various embodiments of the present invention, the characteristics and parameters of a purchaser's computer are ascertained and alternative methods for packaging, transmitting, and instantiating digitally encoded content are considered in order to select a transfer method with low or minimal overhead. In certain embodiments of the present invention, the overhead is computed as a time to usability. In alternative embodiments, different metrics for determining overheads are employed.

### CROSS-REFERENCE TO RELATED APPLICATION

This application claims the benefit of Provisional Application No. 60/585,103, filed Jul. 2, 2004.

### TECHNICAL FIELD

The present invention is related to computer-based information transfer and, in particular, to efficient transfer of digitally encoded content from content providers to purchasers.

### BACKGROUND OF THE INVENTION

Within the field of electronic commerce, nearly all operations that overall constitute a single purchase transaction or fulfillment of a customer order are implemented as a series of smaller processes and sequentially chained together to give the appearance of a single action being performed. The component processes are, however, implemented in a variety of ways and are designed using a variety of different technologies. In general, each of these components is constructed with component-specific design constraints and considerations, including constraints ease of use, scalability, maintainability, robustness, memory usage, speed, processing environment, and development language. When considered from the point of view of the consumer or end user, many of these constraints and considerations are not apparent with respect to the overall operation. Moreover, the computers used by purchasers vary widely in processing power, memory and storage capacities, bandwidth of communications links, and in other parameters and characteristics. For example, a purchaser using a dial-up modem may regard downloading an executable file as painfully slow, but may regard the operation of the downloaded executable file as quite adequate, despite the fact that the executable is computationally demanding, due to the fact that the purchaser's computer has ample processing speed and memory to handle execution of the executable file. Conversely, a second purchaser using a high-speed network may find content easy to retrieve, but slow to use, due to memory or processing speed limitations on the second purchaser's device. When computers within a work environment have processing speeds that range from 16 megahertz to 4 gigahertz, the two-hundred-fold range in processing speed is clearly not conducive to a “one size fits all” solution for obtaining digitally encoded information from remote source computers, and inevitably proves inadequate to one or more users.

Traditionally, applications are designed primarily with regard to only a single variable. A classic example is streaming media, which is almost universally optimized for audio quality based on available communications bandwidth. Real Networks popularized early streaming media by supporting audio compression/decompression mechanisms (“codecs”) that were optimized to provide acceptable audio quality at the commonly available modem speeds of the time. Microsoft enhanced content transfer by engineering the Windows Media Player application to maintain awareness of multiple codecs and separate audio streams, and to either step up to a higher quality stream, when more bandwidth is available, or step down to a lower quality audio stream when bandwidth is too constrained. Similarly, compression technologies based on binary packing are generally optimized for space efficiencies. A compression technology that runs in an acceptable time frame and produces better results than the current standard is generally considered superior. For instance, the BZ2 Binary Zip algorithm generally produces smaller file sizes than the standard ZIP algorithm. The additional computation required to produce a smaller file size is generally considered to be an acceptable tradeoff when an application is optimized for overall space usage. However, when compressed media is accessed in real time, such as when updating a screen or other rendering device or feeding an audio output to speakers, delays in providing data to the output device due to additional computational overhead may cause flicker on the screen or static and gaps in the audio output. For example, the MPEG compression algorithm, when used for compressing audio, referred to as “MP3,” stores audio which is not only compressed with regard to frequency range and psychoacoustic profiling, but also compressed using binary packing. However, MP3 utilizes a relatively lightweight binary packing algorithm in order to be readily decoded on devices with limited computational horsepower and with limited memory capability. A more computationally intensive binary packing algorithm, or a more computationally intensive psychoacoustic audio decoding algorithm, would reduce the size of the overall file, but would require more computational bandwidth to decode, thus requiring a more expensive device and utilizing more power, both unacceptable when the target market is a cheap commercial appliance.

There are a variety of additional concerns with regard to the utility of an end product purchased from a remote content provider. Within a managed environment, for example, a corporate data center, limiting factors are generally well known and controlled for. When power consumption is a concern, for example, more power can be brought into the data center. When thermal output from the hardware becomes excessive, more air conditioning can be added. As computational requirements rise, more hardware or more powerful hardware can be included. When storage requirements increase, additional machinery can be added with more memory or drivespace, or existing devices can be upgraded, or the underlying software and operating system can be amended to utilize disk swap space instead of onboard memory. Outside tightly controlled and managed computing environments, by contrast, it is necessary for an application to adapt to the heterogeneous deployment platforms on which it may be utilized. Modern compilers have facilitated adaptability, allowing for code to be compiled to use chipset-specific features when present, and to use less efficient software implementations of the features when the target computer lacks these features. As usual, there is a tradeoff. An application that contains multiple different means to handle a single command is generally larger than that same application equipped with only a single means of operation. In other words, the application has been optimized for speed, rather than space. However, the limiting factor on speed of execution of an application is not always the speed of processing of the underlying code. As a trivial example, it requires very little computational speed to translate pulse code modulated (“PCM”) audio to audible output through a speaker, a translation easily carried out by the limited microprocessor generally employed in a CD player. However, when the PCM file is being downloaded over a 1200 bps connection and cached in memory, execution may appear to be much slower than realtime. A potentially faster solution involves downloading a compressed version of the audio file, decompressing the compressed file in memory, and then rendering the decompressed file. This potentially faster approach depends on available memory, speed of the processor, size of the file, and the efficiency of compression and decompression.

Designers of on-line retail systems, on-line retailers, and others transmitting digitally encoded content by electronic means have recognized the need for information transmission systems and applications that more efficiently make use of communications, processing, and other computer-related resources and non-computer-related resources to transfer content to purchasers for use by the purchasers.

### SUMMARY OF THE INVENTION

In various embodiments of the present invention, the characteristics and parameters of a purchaser's computer are ascertained and alternative methods for packaging, transmitting, and instantiating digitally encoded content are considered in order to select a transfer method with low or minimal overhead. In certain embodiments of the present invention, the overhead is computed as a time to usability. In alternative embodiments, different metrics for determining overheads are employed.

### BRIEF DESCRIPTION OF THE DRAWINGS

FIGS. 1A-C illustrate major factors in time to usability for transmission of digitally encoded content from a content provider to a purchaser.

FIGS. 2A-D illustrate an example of a number of different approaches to transferring digitally encoded content with different overheads.

FIG. 3 is a control flow diagram of a content-distribution method of the present invention.

### DETAILED DESCRIPTION OF THE INVENTION

The present invention is directed to providing an ideal customer experience to a purchaser of digitally encoded content. In general, a purchaser is most satisfied when the digitally encoded content is available for use or for rendering on the purchaser's computer in as short a time as possible. This shortest time to usability is one possible metric for computing the overhead associated with transferring the digitally encoded content from a content provider to a purchaser. For example, if given the choice between downloading a software application and ordering the software application via postal mail, it is generally preferred to download the software application immediately in order to begin using it as soon as possible.

As an example of evaluation of transfer overhead to select a best transfer method, consider a customer at home who wishes to purchase a new word processor. He utilizes the Internet to sign on to an electronic commerce web site and purchase a digital download of this application. He then downloads a ZIP file containing a compressed version of the application, decompresses the application, and finally installs the application. This process may take only a few minutes for a customer with a high speed computer and capacious broadband connection, or may take hours or days for a customer who receives data through a dialup modem or similar narrowband communications medium and whose computer is relatively slow. A variety of different characteristics and parameters may affect the performance of a computer, including: (1) processor speed; (2) the number of processors resident within the computer; (3) the efficiency of the operating system; (4) the types of network communications protocols employed; (5) the software applications in use on the computer; (6) the amount of memory that can be allocated on the computer; (7) the speed of access to the memory; (8) the capacity and speed of the mass storage devices, such as hard drives, optical drives, or tape; (9) the speed of content rendering or transcription devices, such as CD writers, printers, or plotters; (10) the throughput, reliability, and latency of the network connection; (11) the other tasks being performed concurrently on the computer; (12) the speed and capacity of the internal connections and components in the computer, such as the bus speed, the controller devices for peripherals, and other internal connections and components; and (13) a variety of other characteristics and parameters.

Another example is a customer who wishes to purchase a new book, but who does not necessarily intend to read it immediately. The customer may opt to purchase an electronic book, download the book, decompress the book, and print the book utilizing a laser printer attached to his computer. However, the customer perceives an increased time cost in this model, compared to ordering it online from an e-commerce site, such as Amazon, because the amount of customer interaction required is considerably higher for the model. This interaction overhead can be addressed, to a certain extent, by agent software that handles the download, decompression, and printing of the purchased book in a simple and transparent fashion, thereby eliminating the perceived interaction costs by reducing human intervention.

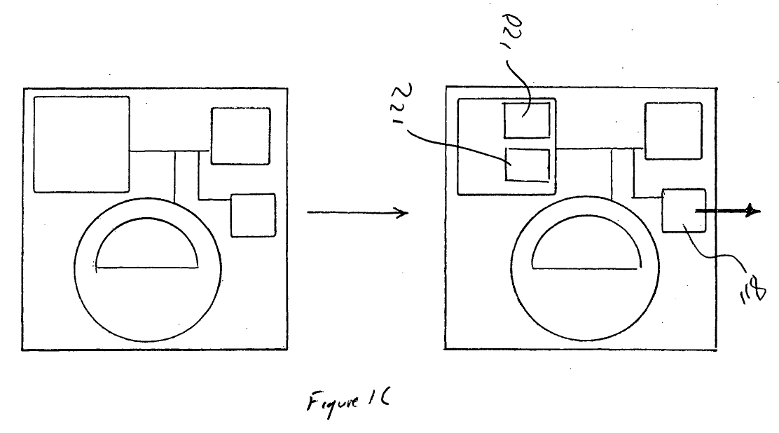

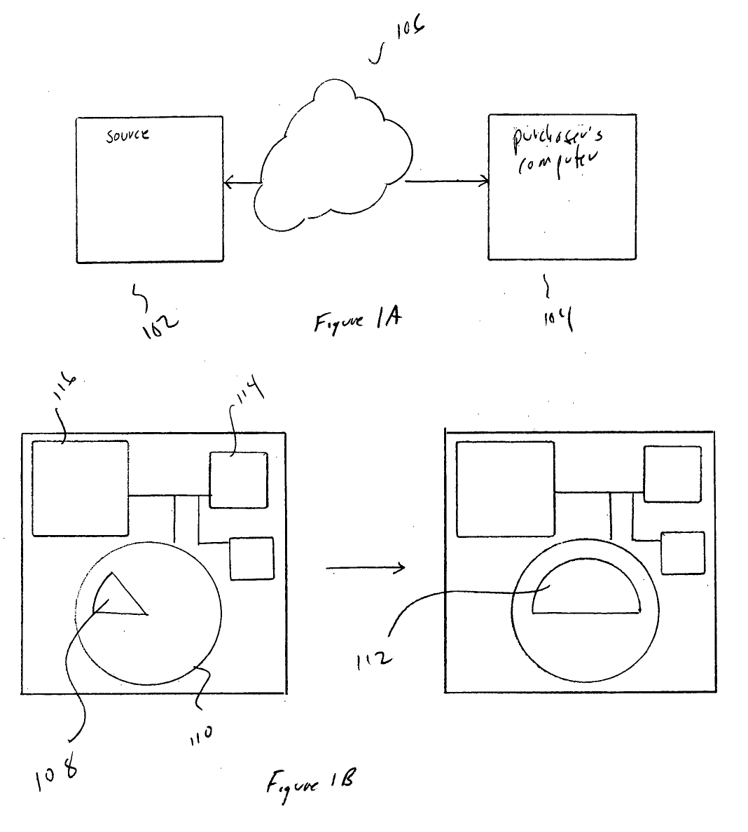

As mentioned above, one possible metric for computing content-transfer overhead is a computed time to usability. FIGS. 1A-C illustrate major factors in time to usability for transmission of digitally encoded content from a content provider to a purchaser. One factor is the time and computational overhead involved in transfer of generally compressed, digitally encoded content, often also encrypted, from a source computer, or content provider to a purchaser's computer, as shown in FIG. 1A. The transfer time depends on a variety of factors, including the characteristics and capacities of the source computer 102 and the purchaser's computer 104, the communications media through which the content is transferred 106, size of the content, and other characteristics, parameters, and factors. Next, as shown in FIG. 1B, the compressed, and often encrypted content 108, stored on an internal hard disk 110, is decompressed and, when necessary, decrypted to produce a renderable or executable form of the content 112. The speed of this decompression and decryption depends on speed of the processor 114, size and speed of memory 116, and many other characteristics and parameters. Finally, as shown in FIG. 1C, execution or rendering of the content needs to be initiated, including preparing a rendering-device controller 118, initializing a rendering application in memory 120, buffering a portion of the content in memory, and other such initiation tasks.

For example, given the choice of downloading a file compressed using two different compression mechanisms, the first computationally intensive but producing a smaller file size, and the second a relatively computationally lightweight mechanism, but producing a larger file, the overall time to usability may be computed as: download time+decompression/decryption time+instantiation time+additional overhead. The additional overhead may relate to the amount of user interaction necessary, the amount and number of computer resources used in the process, and many other characteristics and parameters.

For example, if a consumer with a dialup modem connection and a fast computer requires 6 hours 30 minutes to download a software application, 3 minutes to decompress the software application, and 3 minutes to install software application, it is clear that the bulk of this time is being taken up by the transmission of data. A more highly compressed file might require only 5 hours to download, but require 20 minutes to decompress, and the same 3 minutes to install. Assuming no necessity for user interaction during download and decompression in either case, transfer of the more compressed file has a shorter time to usability, and is therefore preferable.

However, a second consumer might have a much faster network connection and an equally fast computer. In this case, the consumer might require 6 minutes to download the first, less decompressed software application using the lighter compression algorithm, plus the same 3 minutes to decompress and 3 minutes to install software application, whereas the second, more compressed file would require only 5 minutes to download, but still 20 minutes to decompress and 3 minutes to install. In this case, it is clear that downloading the less compressed version of the software application provides a shorter time to usability, and is therefore preferable.

Optimization for superior consumer experience is best handled as a series of choices based on the capabilities of a purchaser's computer. However, if there is significant consumer interaction required as far as software configuration on the part of the end user, a perceptually degraded consumer experience may result. Therefore, an ideal solution relies on an automated series of tests, ideally invisible to the end user, to determine the preferred approach.

The above example represents a binary decision involving only a couple of variables, and assumes that each action is atomic. In reality, a large download might be split into several components, each of which is retrieved separately, validated and decompressed, then concatenated before use. An example is the replication of a software CD. Though a compressed ISO 9660 CD image “ISO file” can be downloaded, decompressed, and then written to disc using a CD writer, more efficient means to retrieve and prepare this content by downloading multiple component files, decompressing each of them, and then merging them into a single ISO image are possible.

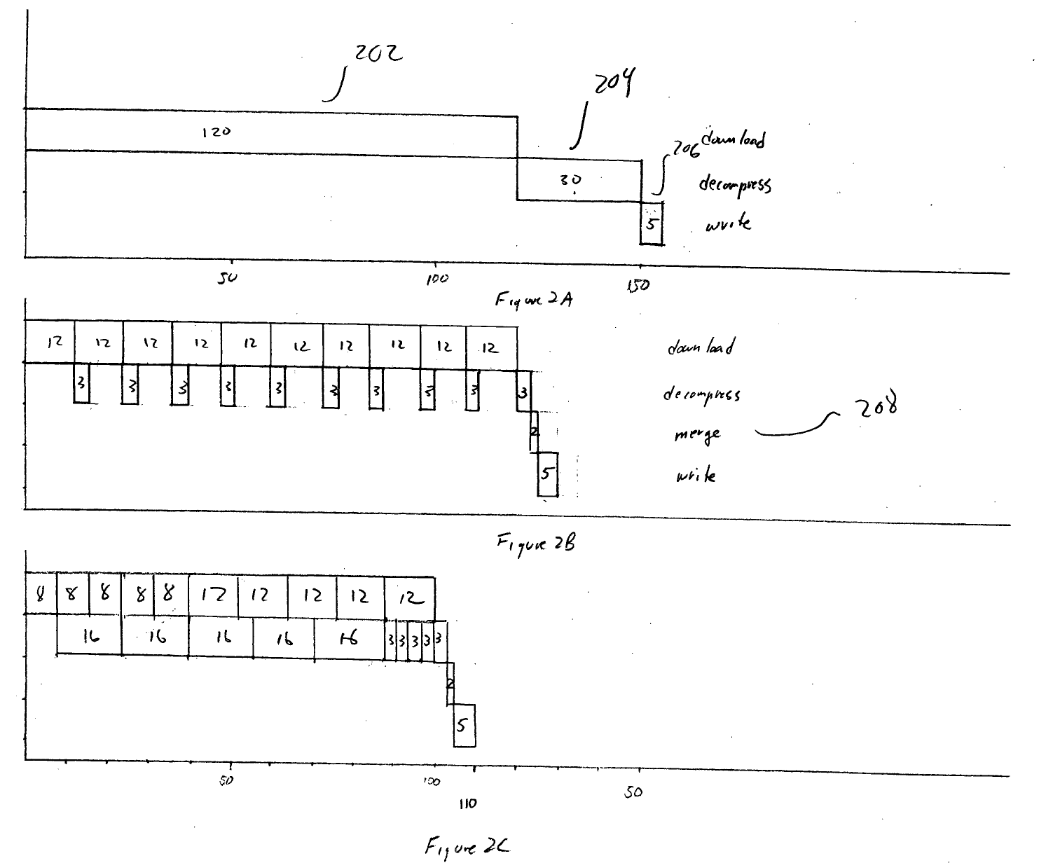

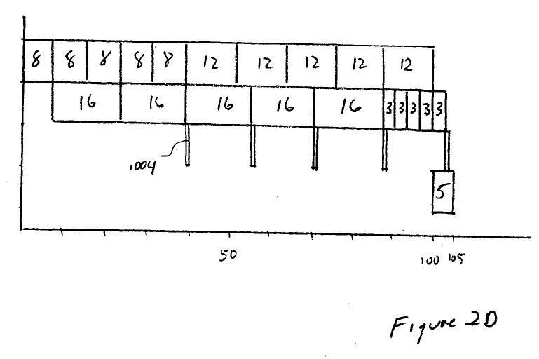

FIGS. 2A-D illustrate an example of a number of different approaches to transferring digitally encoded content with different overheads. In FIGS. 2A-D, the time for completing the transfer operation is shown in a horizontal bar-graph representation, with horizontal axes representing the time, in minutes, for each component operation. The component operations include downloading the CD content, decompressing the downloaded, compressed CD content, and writing the content to a CD on a purchaser's computer the In a first approach, shown in FIG. 2A, downloading the compressed image takes a total of 120 minutes 202, decompressing compressed image takes a total of 30 minutes 204, and writing the decompressed content to disc takes another 5 minutes 206 for a total time to usability of 155 minutes. However, if the CD image is split into ten parts, in a second approach shown in FIG. 2B, each of which is compressed separately, downloading the whole disc takes a total of 120 minutes, or 12 minutes per separately compressed part, decompressing each decompressed part takes a total of 30 minutes, or 3 minutes per part, and an additional stage of merging the decompressed parts into a single ISO image 208 takes an additional 2 minutes, before writing the image to disc, again taking five minutes. Because many of these tasks use different resources of a computer and can thus be done in parallel, the elapsed time to usability is significantly shorter, 130 minutes.

Although the second approach has shortened the time to usability, further improvements are possible. FIG. 2C shows a third approach, in which the first 5 parts are compressed with a more space-efficient but computationally-intensive algorithm, which takes longer to decode than to download. In this example, each part takes only 8 minutes to download instead of 12, but take 17 minutes to decompress. This represents a balance between network time and processor time, utilizing both at optimal efficiency to produce a shorter elapsed time to usability of 110 minutes.

The third approach may seem to be an optimal solution. However, though network usage and processor capabilities are successfully being balanced for elapsed time, the final steps may also be subject to optimization. The concatenation of the various decompressed parts, for example, is relatively processor-light and requires no network usage and is largely constrained by the hard drive controller. A fourth approach, shown in FIG. 2D, performs a variety of smaller concatenations as the decompressed content becomes available, concurrently with other tasks taking place. Also, once it is clear that all the component files have been successfully retrieved, it is possible to begin the process of writing the image to disc before the last components have been merged into the disc image file, when the process of disc writing is sequential and when the parts are decompressed and merged into the image file before the writing device requires their presence.

In practice, of course, a variety of other component operations take place. Transmitted content is often encrypted as well as compressed, but the process of decrypting and decompressing the content can be taken to be synonymous since both are typically processor-intensive. Likewise, downloaded components are typically check-summed to ensure successful download before an attempt is made to decode or decompress them. Similarly, the state of the media writer is generally checked, as well to, ensure that sufficient space is available on the disc in question to transcribe the files being written. Clearly, a real-world implementation of methods of the present invention takes all such potential efficiencies and optimizations into consideration. There is also a potential for time-based optimization of these processes.

The accuracy and efficiency of methods of the present invention may rely on accurate assessment of the capabilities and limitations of the recipient computer and the recipient computer's operating environment, including network connectivity and reliability. Fortunately, profiling performance is well suited to an automated process requiring little or no user interaction and producing accurate metrics. Moreover, this process can be made relatively lightweight, potentially even to the point of performing such analyses on a per-instantiation basis.

Although the above-provided example concerns writing content to an optical disc, or CD, many other examples can be provided for content distribution using methods of the present invention. For example, rather than decompressing an audio file and processing it into pulse code modulated audio for transcription onto a DVD, the audio file may be recompressed audio into some relatively transportable but less computationally intensive format for playback on a mobile device such as a portable MP3 player, a cellular phone, an iPod, a Minidisc, portable memory card, PDA, enhanced stereo, or even simply for playback on a less capable general purpose computing device. In many cases these rendering devices use different media formats and compression mechanisms. For example, the ATRAC3 audio codec is used on the Minidisc but is not supported by most MP3 players.

An extension of the above examples includes the process of delivering relatively large files in a format such that they would span multiple media. A simple example of this occurs with large software packages or video games that require a several-CD installation. For this example, assume the download speed is sufficiently rapid that it is not the primary constraint. A real-world example of this might include a software vending machine with a large number of software CD images stored locally. The process of producing and dispensing three highly-compressed CD images may be longer than that required to produce and dispense four less-compressed CD images. Likewise, it is likely to take much more processing power, and thus possibly absolute time, to decompress and install three highly compressed CDs worth of data as opposed to four CDs of less-compressed data, but might well be perceived by the end user as less time and effort since fewer disc changes are required to install the software embodied on those three discs. In practice, absolute time to install these three CDs may be less than the four-CD version of the same software, due to delays in user interaction while installing the software. This problem is perhaps more acutely expressed when dealing with media that could be made to fit on a single disc instead of two. The necessity to change discs mid-install provides a disproportionate user-time cost. The prospect of simply starting a single-disc install, walking away, and letting it run is often preferable to waiting at the computer to swap discs.

A related observation can be made with regard to streaming media technology. It is typical for media players, such as RealPlayer, Quicktime, or Windows Media Player, to buffer a certain amount of data in memory before starting playback. Traditionally, a simple computation is done to determine how much data to buffer, based on the current rate of download and the total length of the media clip. It is desirable for enough media to be stored in the buffer that playback can proceed without the danger of needing to pause along the way due to insufficient transmission capacity. When the computer user is watching a video stream, and only a section of a video clip plays before running out of data for playback, the user frequently experiences frustration. Therefore, a calculation is done to determine how much of the clip needs to be buffered before playback can commence. A related, and more recent, development provides for several video streams of various qualities to be transferred. When a user's connection to the network proves sufficiently slow that a chosen quality is not achievable using a first, higher quality stream, the media player switches to a second, lower quality stream, thus delivering a continuous stream of data to the consumer, opting for continued interaction at the expense of quality. While this solution does preserve a perceptually continuous stream of data, it is clear that optimizing for network capacity alone may not be the proper choice. A system capable of rapid information processing and decompression may very well be able to process and decode a lower-bandwidth stream of data while still retaining full quality, whereas a less-capable system may have no choice but to resort to a lower-quality stream. Conversely, it can be seen that one network server, delivering file streams to a variety of customers, may well be capable of serving more customers by delivering highly-compressed data to systems capable of decompressing the compressed data in real-time and less-highly-compressed data to less capable systems, thus utilizing less network bandwidth and thereby either lowering costs or permitting more simultaneous streams of data.

The extensibility of this concept should be readily understood by one skilled in the art of software development. For instance, the first example provided above illustrates how software, music or video content can be similarly delivered across a network and transcribed onto optical disc. However, it is clear that physical disc creation is only one of many possible uses for such technology. Other examples include the use of varying compression mechanisms for streaming media, taking advantage of a playback buffer and read-ahead caching to provide superior audio fidelity within a time-limited environment by utilizing a set of differing compression technologies adapted for the capabilities of the rendering device in question, so that a computer with greater processing power but limited bandwidth can produce a higher fidelity audio output by being streamed content that is more effectively compressed, permitting more data per byte of transmission at the expense of requiring a more powerful decoding device. A computationally powerful television-rendering device can obtain highly compressed data across a cable connection and thus render HDTV content without the requirement for an infrastructure upgrade to the cable network. An automated software installer, or auto-update utility or patch mechanism, can optimize for speed of deployment by analyzing capabilities of the end-user's computer and adjusting the approach for transfer and initiation, as discussed above. An application utilizing methods of the present invention can recommend modifications in user behavior, e.g. instead of downloading a large file over a slow connection, the application can recommend purchasing the physical media and having the physical media delivered via FedEx or similar shipping service.

Likewise, the presence of required hardware, software and functionality on the recipient device can be used as a delimiting factor. A computer that lacks the horsepower to natively display MPEG-4 video might instead be delivered a larger MPEG-2 file that can be rendered on that device. In this case, less efficient data transfer is balanced by increased usability of the product. However, when the objective is to use the computer as a conduit for delivery of content to another device, such as downloading a smaller MPEG-4 video and transcoding it to MPEG-1 video for use on a VideoCD, the computer may not be capable of doing this in real time for playback purposes, but may still be capable of downloading the smaller file and transcoding it more quickly than downloading a larger MPEG-1 file.

Lastly, though a general purpose computer network such as the Internet is generally considered an optimal means for delivery of media, this is not necessarily the only way to do deliver media. In a number of cases, it may not be the correct way nor perhaps available at all. A user wishing to obtain multiple gigabytes of data, but having only a relatively narrow network connection, perhaps a dialup connection through an analog modem, may solicit a media delivery and have the optimizer determine that delivery, by courier, of a DVD containing the data is faster than the projected download time. Alternately, a narrowband transmission, such as dialup, might be utilized to make a request, and delivery of the requested data can take place through an alternate data transmission/reception device, such as packet radio or point-to-point wireless network. As an additional interesting prospect, requests by a sufficiently large group of interested customers can warrant the use of general purpose data broadcast, for instance, over an unused terrestrial or satellite television broadcast link, effectively multicasting that data to all potential recipients and utilizing pattern recognition and cryptography to ensure that access is, in fact, delivered only to the desired recipients. This would potentially have a democratizing effect for information distribution, inasmuch as very popular data could be sent out via broadcast/multicast, thus serving the greatest common good. Upon completion of the transmission, a scheduling algorithm can deliver the next most widely requested data chunk, and so forth. There is an additional, interesting prospect for timeslicing two or more data streams of highly compressed information for general purpose broadcast, which would be received by the destination systems and the relevant sections decoded. Interslicing multiple data streams can maintain a constant flow of data at a pace at which the decoding systems can keep up with one of the desired streams, but permitting more data to be fit into a single channel than previously available. This may involve a simultaneous optimization to ensure that data is being delivered at a sufficient rate to all channels, based on the capabilities of the decoder.

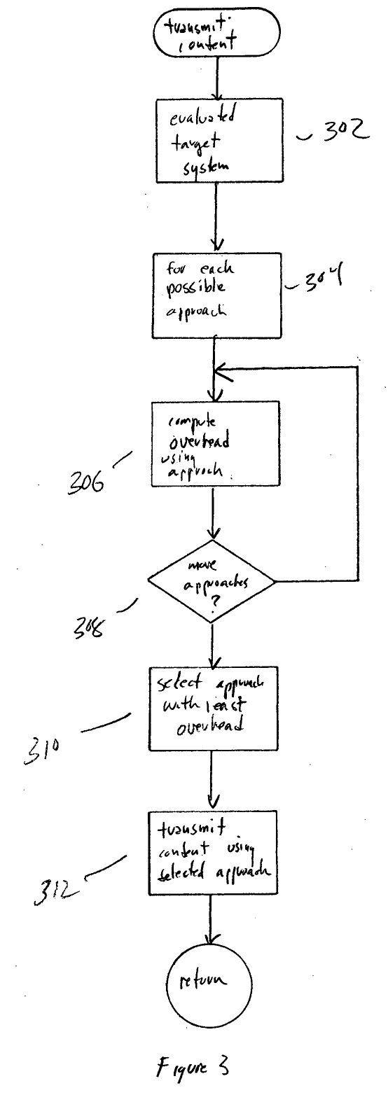

FIG. 3 is a control flow diagram of a content-distribution method of the present invention. In step 302, the capabilities of a target, or purchaser, computer are determined. In the for-loop of steps 304, 306, and 308, each possible approach for distributing the content is considered, and for each approach, an overhead, such as the time to usability, is computed. In step 310, the approach with the least overhead is selected, and used, in step 312, to transfer the content from a content source to the purchaser's computer.

Although the present invention has been described in terms of a particular embodiment, it is not intended that the invention be limited to this embodiment. Modifications within the spirit of the invention will be apparent to those skilled in the art. For example, many different overhead metrics, in addition to time to usability, may be used to select an approach for transferring digitally encoded content. Additional factors, including server performance, usability, quality of user experience, and other such factors may be taken into account in the alternative metrics. The present invention may be embodied in a practically limitless number of different implementations in software, firmware, or a combination of hardware and software, using different modular organization, programming languages, operating-system platforms, data structures, control structures, etc.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method for transferring digitally encoded content from a content-provider computer to a purchaser computer, the method comprising:
evaluating the characteristics and capabilities of the purchaser computer;
considering a number of different approaches for transferring the digitally encoded content from the content-provider computer to the purchaser computer and computing an overhead for each approach;
selecting an approach with a lowest overhead; and
transferring the digitally encoded content from the content-provider computer to a purchaser computer using the selected approach.
